(19) United States
(12) Patent Application Publication
(10) Pub. No.: US 2010/0108462 A1
(43) Pub. Date: May 6, 2010

(54) BILL ACCEPTOR WITH LICENSE RECOGNITION AND POWER-SAVING POWER CONTROL FUNCTIONS

(75) Inventors: Jyh-Chyang Hsieh, Pate City (TW); Yueh-Ping Hsu, Sanchung City (TW); Tien-Yuan Chien, Taipei City (TW)

Correspondence Address: INTERNATIONAL CURRENCY TECHNOLOGIES CORPORATION, 2F-4. NO. 148, SEC. 4, CHUNG HSIAN EAST ROAD, TAIPEI, TW

(73) Assignee: INTERNATIONAL CURRENCY TECHNOLOGIES CORPORATION, Taipei (TW)

(21) Appl. No.: 12/264,256

(22) Filed: Nov. 4, 2008

(51) Int. Cl. G07F 7/04

(52) U.S. Cl. 194/206

(57) ABSTRACT

A bill acceptor for use with an automatic vending machine is disclosed to include a body having a bill/license insertion slot and a passage extending backwards from the bill/license insertion slot, and a circuit assembly, which includes a bill recognition unit for checking the authenticity and par value of a bill, a license recognition unit for checking the authenticity obtaining a predetermined data of a license, a communication interface module for data communication between the bill recognition unit/license recognition unit and the automatic vending machine, and a power-saving power supply module electrically connected with the communication interface module for controlling the automatic vending machine to enter the sleep mode when the automatic b vending machine is not used within a predetermined time period after startup and for providing power supply to wake up the automatic vending machine upon insertion of a bill/license and recognition of the authenticity of the inserted bill/license.

### BACKGROUND OF THE INVENTION

1. Field of the Invention

The present invention relates to a bill acceptor for use with an automatic vending machine and more particularly, to a bill acceptor with license recognition and power-saving power control functions, which saves power consumption and prolongs the service life of the automatic vending machine.

2. Description of the Related Art

Following fast development of technology, the distance among people has been greatly shortened, our mode of living has been changed, and different automatic vending machines are used everywhere to sell different products without serviceman. These automatic vending machines are highly invited for the advantage of saving much labor and bringing convenience to people. For example, a Q-shop has the advantages of scientific intelligence, quick service, and quick finish of payment. A Q-shop may provide automatic vending machines for vending drinks, cigarettes, tickets, ice creams, tickets, memorial coins, key rings, or even hamburgers and noodles. Nowadays, many virtual shops are established to make online shopping, allowing shoppers to shop across millions of products.

Further, more and more numbers of shops utilize automatic vending machines to sell different items for the advantages of saving labor and management cost and raising the profit. However, regular automatic vending machines do not limit sales to any person of any age. To prohibit young children unqualified people from buying controlled items, such as tobacco, wine, or other hazardous items, an automatic vending machine must be equipped with a bill acceptor having license recognition means to recognize the age or identity of the consumer. When using an automatic vending machine that sells controlled items, a user must insert a license (such as driver license, ID card, Health Insurance Card, etc.) into the machine so that the bill acceptor can check the real age and/or identity of the trader.

However, conventional automatic vending machines and bill/license recognition means are constantly kept in the power-on status when started up, wasting power consumption and increasing company running cost. When an automatic vending machine or bill/license recognition means is constantly kept in the power-on status, the internal electronic component parts of the automatic vending machine or bill/license recognition means may get damaged due to heat, shortening the service life or causing the automatic vending machine or bill/license recognition means unable to function normally.

Therefore, it is desirable to provide automatic vending system that eliminates the aforesaid problem.

### SUMMARY OF THE INVENTION

The present invention has been accomplished under the circumstances in view. It is therefore one object of the present invention to provide a bill acceptor for use with an automatic vending machine, which saves power consumption and prolongs the service life of the automatic vending machine.

To achieve this and other objects of the present invention, the bill acceptor comprises a body, and a circuit assembly mounted inside the body. The body comprises a bill/license insertion slot for the insertion of a bill and a license, a passage backwardly extending from the insertion slot, a sensor switch for detection the insertion of a bill/license. The circuit assembly comprises a bill recognition unit for checking the authenticity and par value of a bill, a license recognition unit for checking the authenticity obtaining a predetermined data of a license, a communication interface module for data communication between the bill recognition unit/license recognition unit and the automatic vending machine, and a power-saving power supply module electrically connected with the communication interface module. The power-saving power supply module controls the automatic vending machine to enter the sleep mode when the automatic vending machine is not used within a predetermined time period after startup, and provides power supply to wake up the automatic vending machine upon insertion of a bill/license and recognition of the authenticity of the inserted bill/license.

### BRIEF DESCRIPTION OF THE DRAWINGS

FIG. 1 is an elevational view of a bill acceptor in accordance with the present invention.

FIG. 2 is a sectional view of the bill acceptor in accordance with the present invention.

FIG. 3 is a circuit block diagram of the circuit assembly of the bill acceptor in accordance with the present invention.

FIG. 4 is a circuit block diagram of the power-saving power supply module of the circuit assembly according to the present invention.

FIG. 5 is a system start-up operation flow chart according to the present invention.

FIG. 6 is a license recognition operation flow chart according to the present invention.

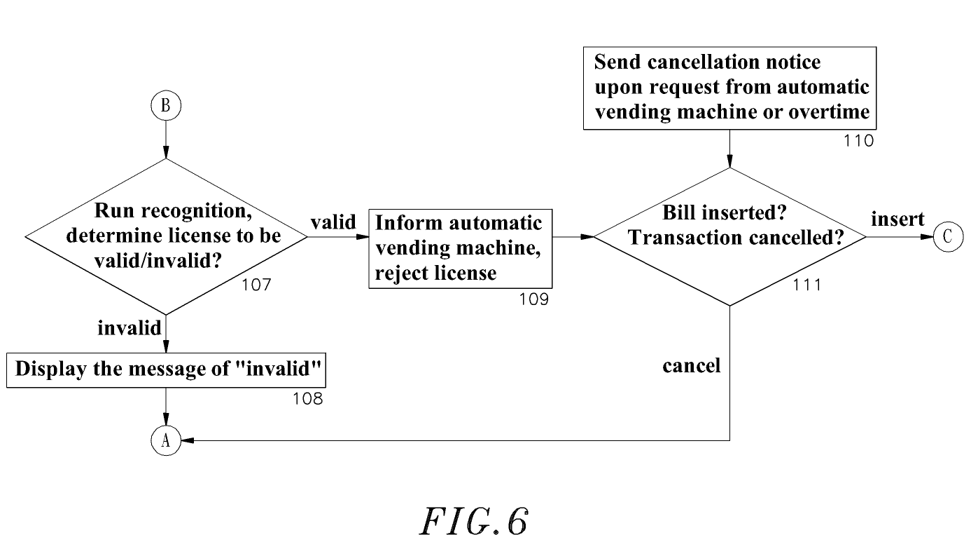

FIG. 7 is a bill recognition operation flow chart according to the present invention.

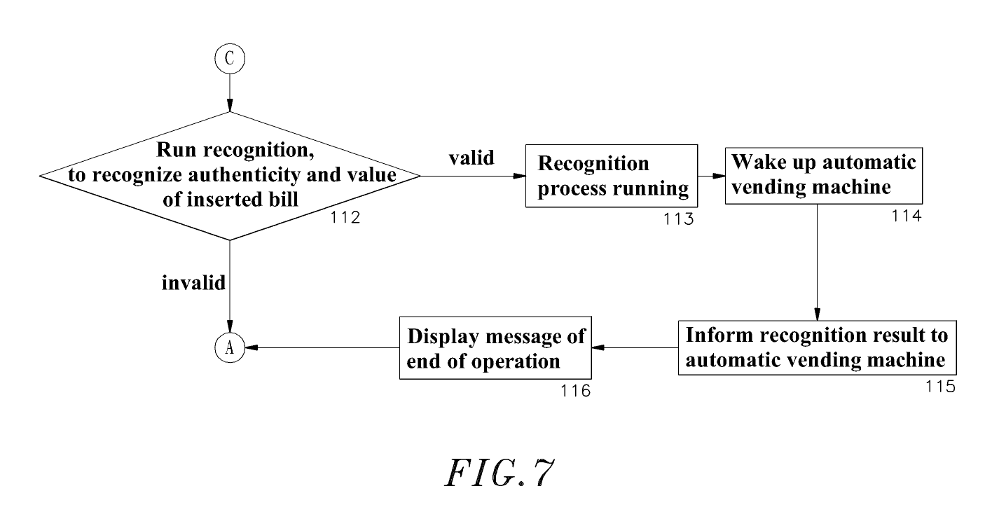

### DETAILED DESCRIPTION OF THE PREFERRED EMBODIMENT

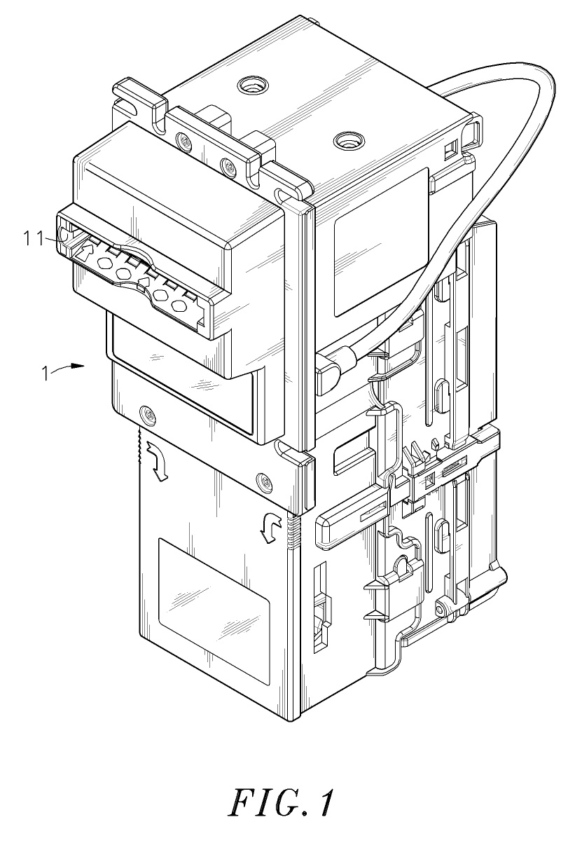

Referring to FIGS. 1˜4, a bill acceptor with license recognition and power-saving power control functions in accordance with the present invention is shown comprising a body 1, and a circuit assembly 2 mounted in body 1.

The body 1 comprises an insertion slot 11 for the insertion of a license and a bill, a passage 12 extending backwards from the insertion slot 11, at least one sensor switch 13 installed in the junction between the insertion slot 11 and the passage 12 and adapted to detect the insertion of a license or bill, a light-shielding gate 14 set adjacent to the sensor switch 13 and controllable by the sensor switch 13 to close/open the passage 12, a bill box 16, which comprises a bill-bearing board 161 disposed at one side of the rear end of the passage 12 and a plurality of spring members 162 that support the bill-bearing board 161, and a transmission mechanism 15, which comprises a motor 151, bill transferring means 152 rotatable by the motor 151 to transfer an inserted bill or license, and a bill holding-down device 153 disposed at the other side of the rear end of the passage 12 and adapted to force a bill away from the rear end of the passage 12 onto a bill-bearing board 161 of the bill box 16.

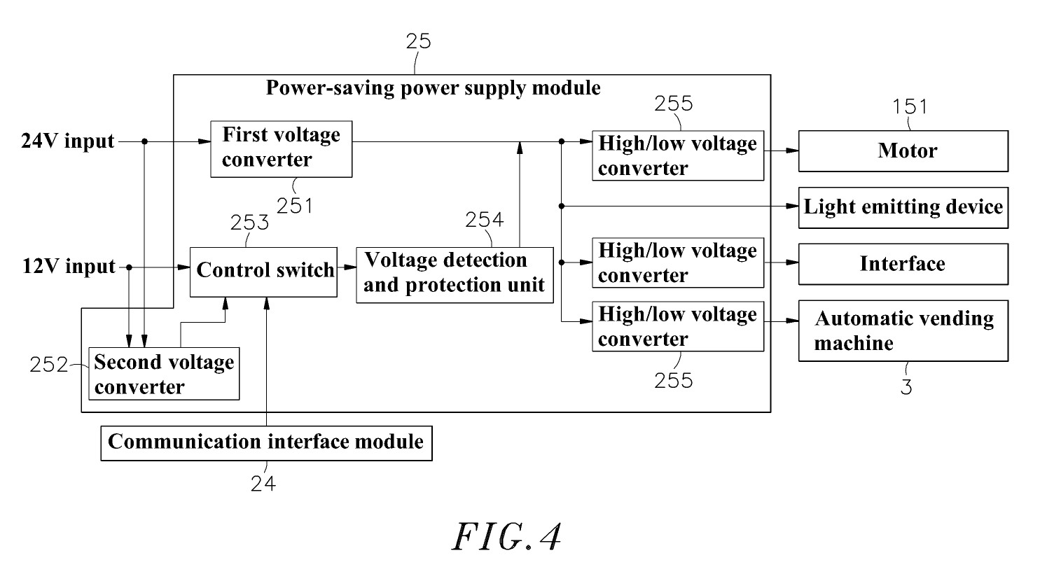

The circuit assembly 2 comprises a bill recognition unit 21 and a license recognition unit 22 respectively disposed around the passage 12 behind the light-shielding gate 14, a transmission control unit 23, a communication interface module 24 electrically connected with the bill recognition unit 21 and the license recognition unit 22 for communication with an automatic vending machine 3 in which the bill acceptor is installed, a power-saving power supply module 25 electrically connected with the communication interface module 24 and the automatic vending machine 3, a software update module 26, and a user interface module 27. The bill recognition unit 21 comprises a first recognition module 211, a bill-checking optical transmitter 212 and a bill-checking optical receiver 213. The license recognition unit 22 comprises a second recognition module 221, a photography light source 222, and an image sensor module 223. The transmission control unit 23 comprises a bill transferring means control module 231 adapted for controlling the movement of the bill transferring means 152, and a bill holding-down device control module 232 adapted for controlling the movement of the bill holding-down device 153. The power-saving power supply module 25, as shown in FIG. 4, comprises a first voltage converter 251 and a second voltage converter 252 for receiving different voltage inputs, a control switch 253 electrically connected with the second voltage converter 252, a voltage detection and protection unit 254 electrically connected with the control switch 253 and adapted to detect, open and close the output voltage of the first voltage converter 251, and high/low voltage converters 255 electrically connected with the first voltage converter 251 and adapted to convert input power into the different working voltages for the body 1 and the automatic vending machine 3. The software update module 26 is electrically connected with the first recognition module 211 of the bill recognition unit 21 for receiving data from the communication interface module 24. The user interface unit 27 is electrically connected with the first recognition module 211 of the bill recognition unit 21, comprising an indication module 271 for transmitting work status data to the automatic vending machine 3 for display, and a DIP switch module 272 for receiving push-button signals from the automatic vending machine 3.

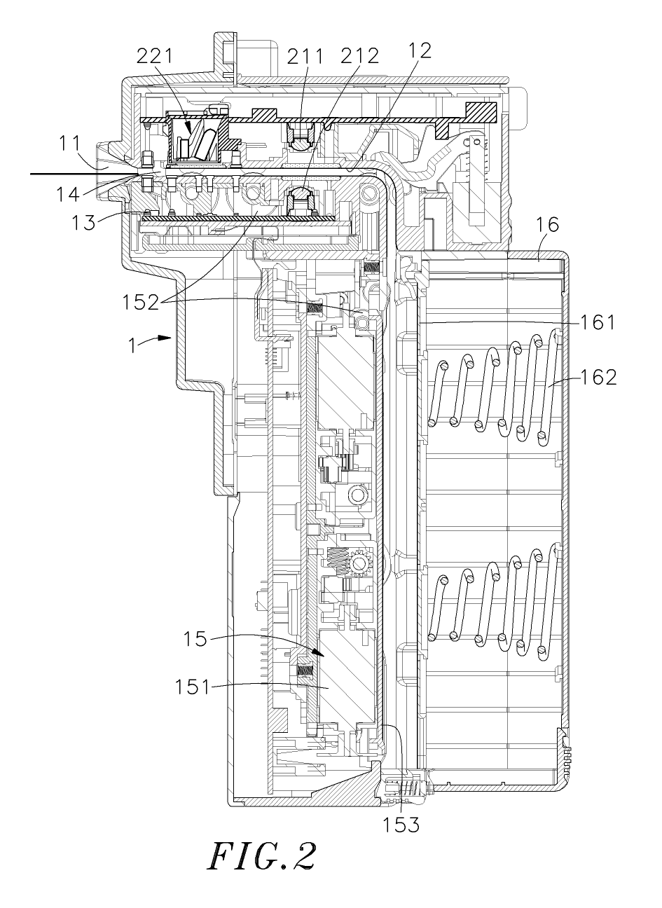

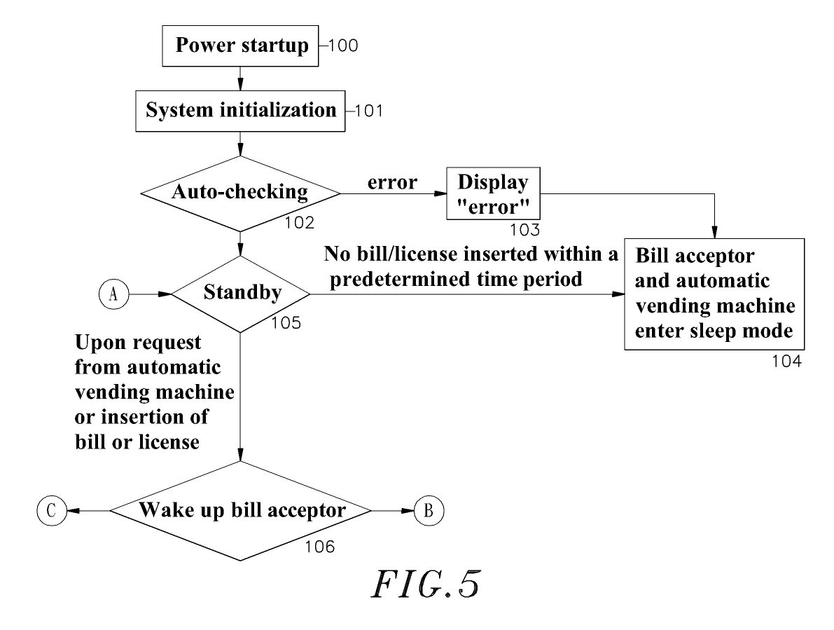

Referring to FIGS. 5˜7 and FIGS. 2˜4 again, the operation of the present invention runs subject to the following steps:
(100) Start-up power supply.
(101) Run the system initialization.
(102) Automatically check the system, and then proceed to step
(103) in case of an error, or step to (105) when normal.
(103) Display the massage “error”, and then proceed to step (104).
(104) The bill acceptor and the automatic vending machine 3 enter the sleep mode.
(105) Stand by, and then return to step (104) when no any bill or license is inserted after a predetermined time period, or proceed to step (106) when receives a request from the automatic vending machine 3 for the insertion of a bill or license.
(106) Wake up the bill acceptor, and then proceed to step (107) if a license is inserted, or step (112) if a bill is inserted.
(107) Recognize the inserted license and then proceed to step (108) if the inserted license is invalid, or step (109) if the inserted license passed the examination.
(108) Display the message of “invalid license” and then proceed to step (105).
(109) Inform the automatic vending machine 3 and reject the inserted license, and then proceed to step (111).
(110) Send a cancellation notice when request or waiting of the automatic vending machine 3 is overtime.
(111) Determine whether a bill is inserted or the transaction is to be cancelled, and then proceed to step (112) when a bill is inserted, or return to step (105) when the transaction is cancelled.
(112) Recognize the authenticity and value of the inserted bill and then proceed to step (113) if the inserted bill is a true bill, or return to step (105) if the inserted bill is a counterfeit.
(113) Recognition process is processing.
(114) Wake up the automatic vending machine 3.
(115) Inform a recognition result to the automatic vending machine 3.
(116) Display the message of end of operation, and then return to step (105).

If no any bill or license is inserted into the insertion slot 11 of the body 1 within a predetermined time period after the bill acceptor and the automatic vending machine 3 have been started up, the bill acceptor and the automatic vending machine 3 immediately enter the sleep mode. When a bill or license is inserted through the insertion slot 11 of the body 1 into the passage 12, the sensor switch 13 is induced to lift the light-shielding gate 14 and to start the transmission mechanism 15, causing the transmission mechanism 15 to carry the inserted bill or license forwards. At the same time, the bill recognition unit 21 or license recognition unit 22 is driven to recognize the authenticity, par value and/or birth data of the inserted bill or license. After recognition of the authenticity of the inserted bill or license, the bill acceptor wakes up the automatic vending machine.

The bill recognition unit 21 and the license recognition unit 22 use the bill-checking optical transmitter 212 or photography light source 222 to radiate the inserted bill or license, and the bill-checking optical receiver 213 or image sensor module 223 to receive reflective light from the bill or license and then to transmit the received light or image data back to the first recognition module 211 or second recognition module 221 for recognition. After recognition, the first recognition module 211 or second recognition module 221 sends the recognition result to the power-saving power supply module 25 through the communication interface module 24, enabling the power-saving power supply module 25 to start up the power supply of the automatic vending machine 3 for running a transaction.

After the bill acceptor and the automatic vending machine 3 entered the sleep mode, the power supply of the bill acceptor will be started up only when a bill or license is inserted into the insertion slot 11 of the body 1, and the power supply of the automatic vending machine 3 will be started up only after recognition of the authenticity of a bill or license been inserted into the insertion slot 11 of the body 1 of the bill acceptor. Therefore, the invention saves the consumption of power supply when the bill acceptor and the automatic vending machine 3 are not used. If a person inserted an ordinary sheet member or a counterfeit bill or license into the insertion slot 11 of the body 1, the automatic vending machine 3 will not be waked up. By means of this two-step power control design, the invention effectively saves the consumption of power supply, avoiding mistaken start-up of the automatic vending machine 3 to waste power consumption and lowering the automatic vending machine running cost.

Further, the indication module 271 of the user interface unit 27 transmits work status data to the automatic vending machine 3, enabling the automatic vending machine 3 to display the message through a display screen, and therefore a user can know the work status of the automatic vending machine 3 in time. Further, the automatic vending machines 3 provides an input device for enabling a user to input signals to the DIP switch module 272 of the user interface unit 27, driving the DIP switch module 272 to operate subject to the input signal. The input device of the automatic vending machine can be a set of operation buttons, a touch screen or switch means.

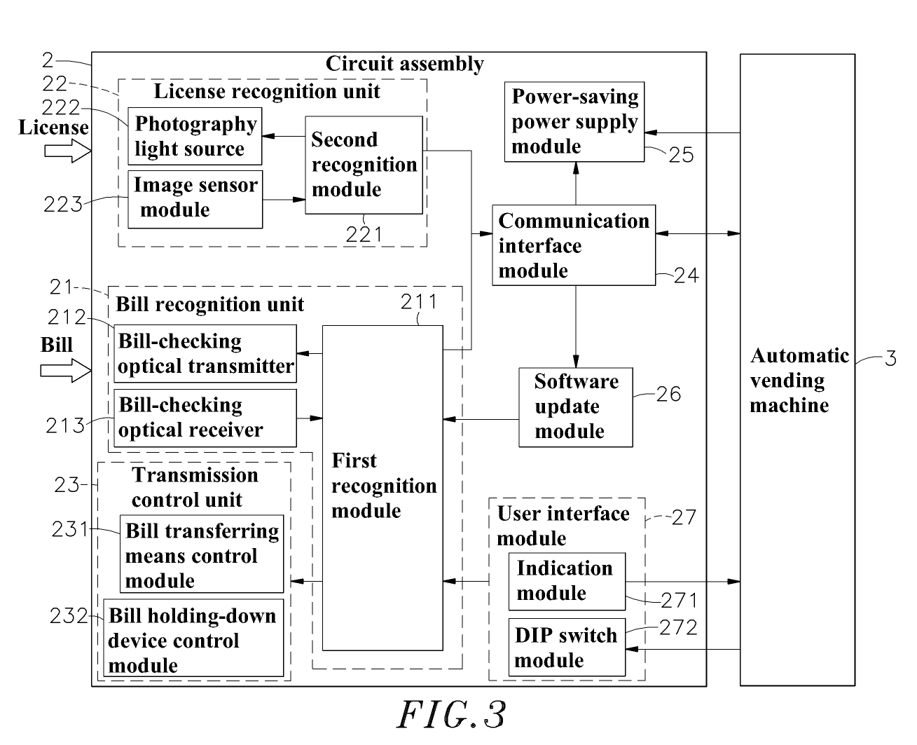

Referring to FIGS. 3 and 4 again, the power-saving power supply module 25 is adapted to receive different input voltages. The relatively higher input voltage, for example, 24V is inputted into the first voltage converter 251 and the second voltage converter 252. The relatively lower input voltage, for example, 12V is inputted into the second voltage converter 252 and the control switch 253. The second voltage converter 252 outputs the converted power supply to the control switch 253. The voltage detection and protection unit 254 is electrically connected with the control switch 253 and electrically connected to the posterior circuit of the first voltage converter 251. The first voltage converter 251 outputs the converted power supply to the high/low voltage converters 255, which convert input power supply into different voltages for the body 1, the motor 151, the bill-checking optical transmitter 212, the automatic vending machine 3 or other component parts for working, or directly transmit input power supply to the body 1, the motor 151, the bill-checking optical transmitter 212, the automatic vending machine 3 or other component parts for working.

The voltage detection and protection unit 254 can detect the output voltage of the first voltage converter 251, and cuts off power supply when the output voltage of the first voltage converter 251 is higher than a predetermined upper limit value or lower than a predetermined lower limit value, protecting the internal electronic devices against a surge and prolonging the service life of the automatic vending machine 3.

Further, the power-saving power supply module 25 can be designed to receive 12V, 24V or other input voltage. The high/low voltage converters 255 can be designed to convert 12V into 3.3V, 5V and/or other voltages.

Referring to FIGS. 1˜4 again, the image sensor module 223 of the license recognition unit 22 can be a charge coupled device (CCD), complementary metal-oxide semiconductor (CMOS), contact image sensor (CIS) or any other type of digital camera adapted to pick up the image and/or anti-counterfeit characteristics (watermark, steel stamp, hidden barcode, laser mark, etc.) of a license or bill.

Referring to FIG. 2 again, the bill transferring means 152 of the transmission mechanism 15 can be comprised of sheet-transfer rollers, transmission belt means, caterpillar chain means, rolling balls, etc. that can be rotated to transfer a license or bill. Further, the bill holding-down device 153 of the transmission mechanism 15 can be a crossed linkage, electromagnetic valve, push board or any other means capable of pushing a bill away from the rear end of the passage 12 onto the bill-bearing board 161 of the bill box 16.

In conclusion, the bill acceptor with license recognition and improved power control arrangement of the present invention has the following features and advantages:

1. If the automatic vending machine 3 is not used within a predetermined time period after start-up, the automatic vending machine 3 immediately enters the sleep mode. When a bill or license is inserted through the insertion slot 11 of the body 1 into the passage 12, the bill recognition unit 21 or license recognition unit 22 is driven to recognize the authenticity, par value and/or birth data of the inserted bill or license. After recognition of the authenticity of the inserted bill or license, the bill recognition unit 21 or license recognition unit 22 outputs a signal to the power-saving power supply module 25, enabling the power-saving power supply module 25 to wake up the automatic vending machine 3. Therefore, the automatic vending machine 3 is kept in the sleep mode when a user inserts a counterfeit license or bill or any other object into the insertion slot 11 of the body 1, saving power consumption and avoiding waste of power supply.

2. If the bill acceptor is not used within a predetermined time period after start-up, the bill acceptor immediately enters the sleep mode while keeping the sensor switch 13 in action. When a user inserts a license or bill into the insertion slot 11 of the body 1, the sensor switch 13 will be induced to wake up the bill acceptor, driving the bill acceptor to work. By means of the two-step sleep/wakeup functioning of the bill acceptor and the automatic vending machine 3, the invention effectively saves the consumption of power supply, avoiding waste of power supply.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A bill acceptor comprising:
a body, said body comprising an insertion slot for the insertion of a bill and a license, a passage backwardly extending from said insertion slot, a bill box disposed at a rear end of said passage and adapted for receiving a bill from said passage, and a transmission mechanism adapted for transferring an inserted license or bill from said insertion slot into said passage for recognition and transferring a recognized bill from said passage to said bill box; and
a circuit assembly mounted in said body, said circuit assembly comprising a bill recognition unit, said bill recognition unit comprising a bill-checking optical transmitter, a bill-checking optical receiver and a first recognition module and adapted for checking the authenticity and par value of a bill, a license recognition unit, said license recognition unit comprising a photography light source, an image sensor module and a second recognition module and adapted for checking the authenticity of a license and obtaining a predetermined data from the license being checked, a communication interface module electrically connected to an external automatic vending machine for data communication between said automatic vending machine and said bill recognition unit and said license recognition unit, and a power-saving power supply module electrically connected with said communication interface module and adapted for controlling the supply of a power supply to start up said automatic vending machine subject to an recognition result of said bill recognition unit and said license recognition unit after insertion of a bill/license into said insertion slot.

2. The bill acceptor as claimed in claim 1, wherein said body further comprises a sensor switch adapted to detect the insertion of a bill/license into said insertion slot and to start said transmission mechanism upon detection of the insertion of a bill/license into said insertion slot.

3. The bill acceptor as claimed in claim 2, wherein said body further comprises a light-shielding gate set adjacent to said sensor switch and controllable by said sensor switch to close/open said passage.

4. The bill acceptor as claimed in claim 1, wherein said transmission mechanism comprises a motor, bill transferring means rotatable by said motor to transfer a bill/license, and a bill holding-down device disposed at the rear end of said passage and adapted to force a bill away from the rear end of said passage into said bill box; said circuit assembly further comprises transmission control unit, said transmission control unit comprising a bill transferring means control module adapted for controlling the movement of said bill transferring means, and a bill holding-down device control module adapted for controlling the movement of said bill holding-down device.

5. The bill acceptor as claimed in claim 4, wherein said bill box comprises a bill-bearing board disposed at one side of the rear end of said passage and a plurality of spring members that support said bill-bearing board.

6. The bill acceptor as claimed in claim 1, wherein said power-saving power supply module comprises a first voltage converter adapted for converting a first input voltage into a predetermined voltage, a second voltage converter adapted for converting a second input voltage into a predetermined voltage, a control switch electrically connected with said second voltage converter for controlling output of said second voltage converter, and a voltage detection and protection unit electrically connected with said control switch and adapted to detect, open and close the output voltage of said first voltage converter.

7. The bill acceptor as claimed in claim 6, wherein said power-saving power supply module further comprises a high/low voltage converter means electrically connected with said first voltage converter and adapted to receive output voltage from said first voltage converter and to convert received input voltage into different working voltages for the operation of said body and said automatic vending machine.

8. The bill acceptor as claimed in claim 1, wherein said circuit assembly further comprises a software update module adapted for transmitting data from said communication interface module to said first recognition module of said bill recognition unit.

9. The bill acceptor as claimed in claim 1, wherein said circuit assembly further comprises a user interface module electrically connected with said first recognition module of said bill recognition module, said user interface unit comprising an indication module for transmitting the work status data of said bill recognition unit to said automatic vending machine for display, and a DIP switch module for receiving input signals from said automatic vending machine.
